(19) United States
(12) Patent Application Publication
(10) Pub. No.: US 2005/0018738 A1
(43) Pub. Date: Jan. 27, 2005

(54) Method and apparatus for laser marking on finished glass disk media

(76) Inventors: Jun Duan, Singapore (SG); Teng Soon Wee, Singapore (SG); Jing Zuo, Singapore (SG)

Correspondence Address: LAWRENCE Y.D. HO & ASSOCIATES PTE LTD, 30 BIDEFORD ROAD, #07-01, THONGSIA BUILDING, SINGAPORE, 229922, SG

(21) Appl. No.: 10/880,468

(22) Filed: Jul. 1, 2004

(30) Foreign Application Priority Data
Jul. 2, 2003 (SG) 200303861-9

(51) Int. Cl. H01S 3/22; H01S 3/10; H01S 3/13

(52) U.S. Cl. 372/55; 372/29.02; 372/25

(57) ABSTRACT

There is disclosed a laser marking apparatus that is able to form dome-shaped marks on a finished glass disk that are visible to naked eyes. The laser marking apparatus comprises a CO₂ laser beam generator, a pulse calibration, a beam modifying and energy stabilizing system, an attenuator, a galvanometer, and a material handling unit. There is also disclosed a laser marking method that comprises calibrating the laser beam generated by the laser beam generator by pulse calibration, passing the calibrated laser beam from the laser generator through the attenuator and the beam modifying and energy stabilizing system, wherein the laser power can be selected, the laser mode can be improved, and the fluctuation of laser power from laser generator and optic path can be minimized, and directing the modified laser beam into the galvanometer, wherein the modified laser beam is directed by an x-y scanner and focused by F-Theta lens to the surface of a workpiece held by the materials handling unit.

### FIELD OF THE INVENTION

The present invention relates to technology of laser marking on finished disks and more particularly to an apparatus for laser marking on the surface of finished glass disks and a method of using the apparatus.

### BACKGROUND OF THE INVENTION

Disks in a disk drive are made of a variety of materials. High capacity magnetic disks use a thin film magnetic medium plated or vacuum deposited upon a substrate. Protective and lubricating layers may be applied over the magnetic active layer. Most commonly, the substrate of the disk is made of metal, plastic, or glass material. The use of non-metallic substrates such as glass or glass-ceramic substrates has gained widely acceptance in the industry due to the superior mechanical advantages of glass and glass-ceramic material. A glass based substrate provides a smoother surface for magnetic layer. The smoother the recording surface, the closer the proximity of the writing/reading head to the disk. This allows more consistent and predictable behavior of the air bearing support for the writing/reading head which enables a higher recording density.

A finished disk can be marked or labelled with alphanumeric writings, codes or indexes. Obviously, disk marking on a finished disk is useful in many ways. For example, the marking can be used to determine when and where the disk was manufactured. Then, it is easy to trace the origin of faulty disks. Therefore, the marking enhances quality assurance process. Moreover, the marking of a disk can be used to classify disks when a disk has been determined of whether it is suitable for further rework. In addition, a finished disk with one defective side can still be used in a load/unload drive and not necessarily in a contact start/stop drive. In this situation, the marking of alphanumeric characters or codes or indexes on the defective side of the finished disk can be used to distinguish the good side from the defective one. Thus, wastage is minimized.

A finished disk can be marked in a few ways. One conventional method is using a scriber to cut into the delicate disk surface. Undesirably, the scriber abrades and damages the top layers of the disk. Another one is ink marking that transfers the inscription onto the disk surface by using a jet of liquid ink or a pen with a felt tip. However, the finished disk from these methods suffers deterioration and contamination.

Laser has been used to produce bumps on the surfaces of a hard disk for creating landing zones with improving tribology performance for the data transducing heads or a calibration disk for calibrating the fly height of a glide head. See, e.g., U.S. 2003/0015018, U.S. Pat. Nos. 5,062,021, 5,863,473, 5,912,791, 5,978,189, 5,847,823, 5,956,217, 6,117,620 and 6,164,118.

Laser has also been used for marking of metal disks. For example, U.S. Pat. No. 6,403,919 discloses a laser marking system for forming a single track marking zone on thin film magnetic disks. The laser marking system disclosed uses Q-switched YAG laser, and, more relevantly, forms the marking zone on an unfinished disk (Al substrate and NiP alloy texture only). U.S. Pat. No. 6,395,349 discloses a method for laser marking the defective side of a magnetic disk by forming a rippled or crinkled mark that is visible to the naked eye. The marking system of '349 marks on finished disks but with an Al substrate. U.S. Pat. No. 6,518,540 discloses a laser marking system that uses a diode-pumped Q-switched laser to create a visible laser-induced ripple structure without ablation of the protective carbon layer on the finished metallic disk surface. The disclosed laser marking systems can mark a finished metallic disk without contamination or damage.

There is, however, no laser marking system for marking a finished non-metallic substrate (e.g., glass) disk. Since glass materials are optically transparent in the near IR wavelength range, a CO₂ laser but not a vanadate laser is used for zone texturing raw glass substrates. The textured glass substrates can then be processed to the finished magnetic disk by conventional manufacturing process. See, e.g., U.S. Pat. No. 6,107,599. One attempt has been made to provide a process for texturing a finished glass disk by a near infrared wavelength laser such as a vanadate laser. See, U.S. 2003/0044647. However, the height of laser bumps produced in this US patent application is too low to create visual contrast.

Therefore, there is an existing need of a laser marking system that can produce visual marks on finished non-metallic substrate disks, especially finished glass substrate disks.

### SUMMARY OF THE INVENTION

The present invention relates to a laser marking apparatus for marking a finished magnetic disk and a method for the application of the laser marking apparatus. More specifically, the laser marking apparatus of the present invention is able to form dome-shaped marks on a finished glass disk that are visible to naked eyes. The laser marking apparatus comprises a CO₂ laser beam generator, a pulse calibration, a beam modifying and energy stabilizing system, an attenuator, a galvanometer, and a material handling unit. The laser marking method of the present invention comprises calibrating the laser beam generated by the laser beam generator by pulse calibration, passing the calibrated laser beam from the laser generator through the attenuator and the beam modifying and energy stabilizing system, wherein the laser power can be selected, the laser mode improved, and the fluctuation of laser power from laser generator and optic path minimized, and directing the modified laser beam into the galvanometer, wherein the modified laser beam is directed by an x-y scanner and focused by F-Theta lens to the surface of a workpiece held by the materials handling unit.

Accordingly, one object of the present invention is to provide a laser marking apparatus that adopts a CO₂ laser to induce dome-shaped bumps on the surface of a finished glass disk, wherein the dome-shaped bumps can form alphanumeric characters, bar-code or indexes.

Another object of the present invention is to provide a method and apparatus for speedily and precisely marking a finished glass disk magnetic storage media with a laser in such a way that the protruding structure is visible to naked eyes, yet the protective carbon layer of the disk is intact and free of ablation.

A further object of the present invention is to provide a method and apparatus for creating protruding structure on the surface of a finished glass disk during a marking process without contamination of the disk surface.

The objects and advantages of the invention will become apparent from the following detailed description of preferred embodiments thereof in connection with the accompanying drawings in which like numerals designate like elements.

### BRIEF DESCRIPTION OF THE DRAWINGS

FIG. 1 is a schematic diagram of one embodiment of the CO₂ laser marking apparatus for a finished glass disk;

FIG. 2 is an illustration of the function of the pulse calibration, (a) the laser pulse vs. command pulse without calibration, (b) the laser pulse vs. command pulse with calibration;

FIG. 3 is an expanded schematic diagram of the beam modifying and energy stabilizing system;

FIG. 4 is an illustration of the attenuator with two Brewster windows, (a) the normal plane of the pair Brewster windows is set at 0° with reference to the P polarized plane, (b) the normal plane of the pair Brewster windows is set at 90° with reference to the P polarized plane;

FIG. 5 is an illustration of the handling unit;

FIG. 6 is a schematic diagram of another embodiment of the CO₂ laser marking apparatus for a finished glass disk;

FIG. 7 is an example of the SEM image of the lasing bumps formed on the surface of finished glass disk by a scanning pulsed laser beam;

FIG. 8 is a sample of the alphanumeric characters and different shape indexes formed by bumps induced by the laser marking system on the surface of a finished glass disk;

FIG. 9 shows two samples of the layered structure of a typical finished glass disk, (a) the layered structure without nickel phosphorous, (b) the layered structure with nickel phosphorus;

FIG. 10 is a representative of an AFM image of the CO₂ laser-induced protruding structure formed without cracked and burned out during laser marking on a finished glass disk with nickel phosphorus;

FIG. 11 is a representative of an AES radial position analysis; (a) a showing of the AES radial position performed on the structure as shown in FIG. 10; (b) the AES radial results of the irradiated region; (c) the AES radial results of a non-irradiated region on the same disk specimen; wherein the results indicate that the carbon, the magnetic, the chromium and the nickel phosphorus interfaces are still preserved beneath the surface after laser marking;

FIG. 12 shows a structure with a cracked and burnt through morphology induced by a higher energy of laser pulses;

FIG. 13 is a representative of an AES radial position performed on the center region of bumps as shown in FIG. 12; wherein no spectra were collected on Points 1 to 4, indicating the damage to glass substrate;

FIG. 14 is a representative of the AES radial position performed on the fringe of the bumps as shown in FIG. 12; (a) a showing of designated spots from which the data were collected; (b) the AES radial position results indicating that points from 1 to 3 have a mixture of carbon, chromium, sodium, silicon and chlorine;

FIG. 15 is a representative of the AFM image of the YAG laser-induced protruding structure without cracked and burnt out on a finished glass disk with nickel phosphorus; and

FIG. 16 is a representative of the AFM image of the YAG laser-induced protruding structure with cracked and burnt out on a finished glass disk with nickel phosphorus.

### DETAILED DESCRIPTION OF THE DRAWINGS

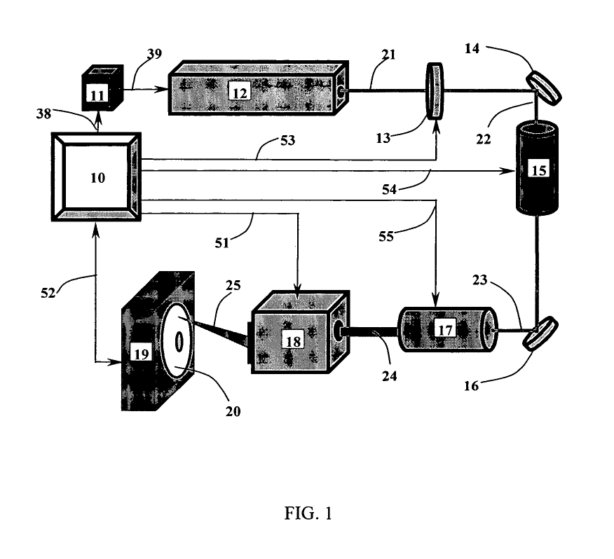

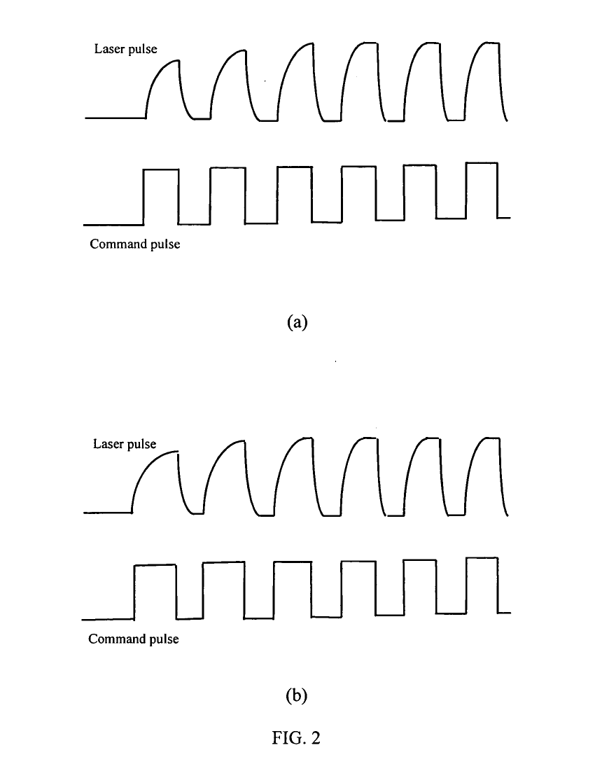

Referring now to the drawings in detail wherein like reference numerals have been used throughout the various figures to designate like elements, there is shown in FIG. 1 one embodiment of the laser marking apparatus constructed in accordance with the principles of the present invention.

The laser marking apparatus of the present invention employs a CO₂ laser for marking on the surface of a finished nonmetallic disk such as a finished glass or ceramic-glass disk, as will be discussed below. In an ordinary CO₂ laser marking apparatus, poor beam mode, high fluctuation of laser power and non-uniform energy of laser pulses cause extreme instability of the laser marking beam, where the instability results in great variations of the height of laser-induced protruding structures. The height variation brings serious problems to laser marking on a finished disk because the carbon overcoat is usually very thin, e.g., about 50 angstrom in many finished disks. On the one hand, the protective carbon overcoat on finished glass disks has been cracked or burnt out in some higher protruding bumps, resulting in interdiffusion between different layers. The interdiffusion between the layers can then lead to possible problems of reliability due to contamination of the surface layer by the underlying layers. On the other hand, the height of some lower protruding bumps is too low to be visible to naked eyes. In overcoming the shortcomings of the ordinary CO₂ laser marking apparatus, the laser marking apparatus of the present invention provides a laser beam with a good beam mode, low fluctuation of laser power and uniform energy of laser pulses. Therefore, the laser marking apparatus of the present invention produces on a finished nonmetallic disk protruding structures with uniform or substantially uniform heights.

Referring now to FIG. 1, in one embodiment, the laser marking apparatus of the present invention for a finished glass disk comprises a CO₂ laser generator 12, a shutter 13, a first beam reflector 14, an attenuator 15, a second beam reflector 16, a beam modifying and energy stabilizing system 17, a galvanometer 18, and a material handling unit 19.

The CO₂ laser generator 12 comprises a laser head and power supply with water-cooling. In some embodiments, the pulse width modulation (PWM mode) with M²<1.2, unitary frequency and a wavelength of 10.6 μm are employed in laser marking processes in the application of the laser marking apparatus of the present invention. Suitable CO₂ laser generators include the GEM-series manufactured by Coherent Inc. (5100 Patrick Henry Drive, Santa Clara, Calif. 95054 USA) and the 48 Series CO₂ lasers manufactured by Synrad, Inc. (4600 Campus Place, Mukilteo, Wash. 98275 USA).

Still referring to FIG.1, the pulse calibration 11 includes one software used to eliminate the effects of lasing gas thermal inertia on each pulse. As is known, a CO₂ laser is a gaseous one that requires a finite time to create a plasma state within the laser resonator after receiving a pulse command 38 from a PC processor 10. The finite time is unpredictable and depends heavily on the amount of time during which the laser has been turned off before a pulse is applied. This results in different pulse-to-pulse rise time of laser pulses so that the energy of each pulse varies. A disclosed solution for unequal pulses adopted a trickle pulse to pre-ionize the laser gas so that it is just below the lasing threshold. This trickle pulse method is efficient for short time off. However, for a longer time off, the first few laser pulses are still greatly inconsistent, as shown in FIG. 2a. Without intention to be bound by any explanations or theories, the inventors believe that the great inconsistence may be due to the gas thermal inertia or temperature difference between the first few pulses and later stabilized pulses. This inconsistent and unstable laser pulse-to-pulse can cause severe problems in precision micro-processing application. The pulse calibration 11 applies a pulse-width compensation 39 for first few command pulses to calibrate the energy in each laser pulse untill they have constant energy, as shown in FIG. 2b. The calibrating procedure is to check the height of first several bumps compared with the height of later stabilized bumps. If the height of the first several bumps is lower than that of the stabilized bumps, the width of the command pluses for the first few laser pulses is increased accordingly till their heights are as same as that of the stabilized bumps. Then, the parameters of the width of the pulses will be stored in the software. Therefore, the software would automatically apply the same parameters to all the first few pulses whenever the laser generator is switched on.

The shutter 13 is an optional safety switch, placed in the optical path to block off the laser beam 21 when the irradiation is not needed or malfunction happens. The shutter 13 receives the commanding signal 53 from the PC processor 10 to maintain a proper status as being either open or closed. The safety switch for blocking a laser beam is known to one skilled in the art. Thus, any safety switch means capable of blocking off the laser beam can be included in the laser marking apparatus of the present invention.

The first reflector 14 is an optional mirror that is used externally as a beam bender in the beam optical path to change the delivering direction of the laser beam and deliver the laser beam into the attenuator 15.

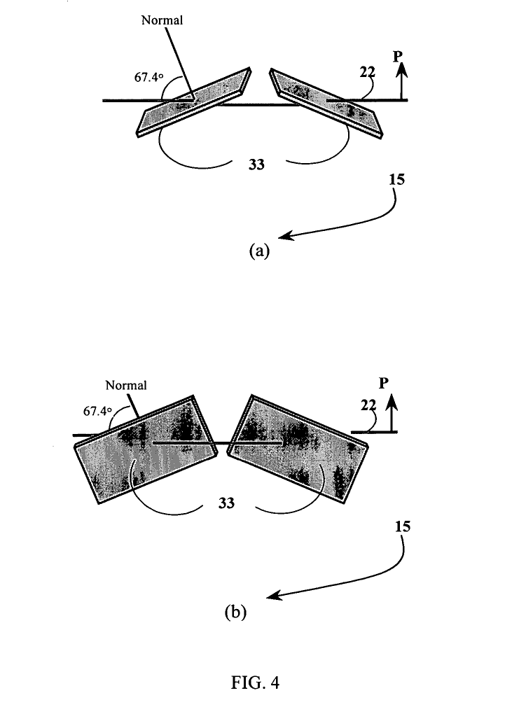

Referring to FIGS. 1 and 4, the attenuator 15 comprises two rectangular Brewster windows 33. The Brewster windows have been used for controlling laser power. For example, U.S. 2003/0086451 discloses a method and apparatus for controlling laser power, using at least two Brewster windows which are aligned along an axis which is parallel to the direction of the laser beam and which are rotatable around said axis, wherein the first Brewster window is rotated in one direction and the second Brewster window is rotated in the opposite direction. However, this method has not been used in a CO₂ laser marking apparatus.

The two Brewster windows 33 of the attenuator 15 operates at an angle of incidence equal to the “Brewster angle” 67.4° for ZnSe material and wavelength 10.6 micrometer, as shown in FIG. 4. They fully transmit linearly polarized light in the P-plane component 22 of the beam where the normal plane of the pair Brewster windows is preset at 0° with reference to the P polarized plane, as shown in FIG. 4a. They almost obstruct linearly polarized light in the P-plane component of the beam where the normal plane of the pair Brewster windows is preset at 90° with reference to the P polarized plane, as shown in FIG. 4b. Consequently, they can be used to adjust the beam intensity by rotating it about the beam axis between 0° and 90° as an attenuator. The rotating adjustment can be operated by a manual method or a motor controlled by a signal 54 from the PC processor 10.

The second reflector 16 is similar to the first reflector 14. It is also an optional mirror used externally as a beam bender in the beam optical path to change the delivering direction of the laser beam and deliver the laser beam into the beam modifying and energy stabilizing system 17. The means for reflecting laser beams in order to change the directions of the laser beams are well known to one skilled in the art. Thus, any known means capable of such a function are included in the present invention.

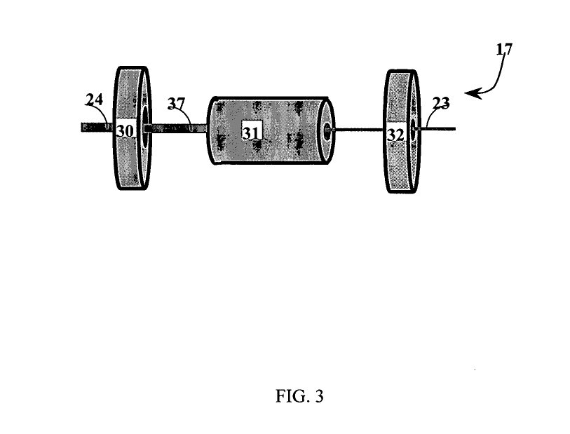

Referring now to FIGS. 1 and 3, the beam modifying and energy stabilizing system 17 comprises a first adjustable aperture 32, a second adjustable aperture 30, and one beam collimator/expander 31. As is known, a regular laser beam without modification and stabilization is so instable that it cannot be fitted into marking process. Therefore, the present invention employs the beam modifying and energy stabilizing system 17 to eliminate the laser power instability unsuitable for the marking process, and produce a high quality laser beam with uniform distribution of energy that is prefect for the marking process. More specifically, the first adjustable aperture 32 improves the Al beam 23 quality from the laser generator. By way of selecting beam mode, which improves the beam from a non-circle into a circle shape, makes the A1 beam 23 become true Gaussian distribution TEM₀₀ mode. The C/E beam 37 is referred to one after passing through the beam collimator/expander 31 that amplifies and collimates the beam 23. Any beam collimator/expander known to one skilled in the art can be used in the present invention. The suitable ones include HMBE/94 manufactured by Umicore Laser Optics (Unit 2 Caxton Place, Caxton Way, Stevenage, Herts. SG1 2UG, UK). The second adjustable aperture 30 is alters the diameter of the C/E beam 37. The beam after the second adjustable aperture 30 is referred to A2 beam 24 that produces a desired beam spot size after being focused onto the disk surface. Both the first adjustable aperture 32 and the second adjustable aperture 30 can be adjusted by manual method or motors controlled by a command signal 55 from the PC 10. Both the first adjustable aperture 32 and the second adjustable aperture 30 help to minimize the fluctuation of pulse energy from the laser generator and optic path by cutting off some of the laser beam when the laser beam passes through both apertures. Suitable adjustable apertures include Iris Diaphragms manufactured by OptoSigma Corporation (2001 Deere Avenue, Santa Ana, Calif. 92705, USA).

The galvanometer 18 comprises a x-y scanner and a double F-Theta lens. The galvanometer 18 receives the A2 beam 24 after the laser beam has passed the beam modifying and energy stabilizing system 17. The laser beam from the galvanometer 18 is referred to the G beam 25. The galvanometer 18 can position and focus the G beam 25 onto the stationary finished glass disk surface 20. When the galvanometer 18 receives a marking instruction from the PC processor 10, the G beam 25 scans across the disk surface to start the marking process by inscribing desired patterns on the disk surface.

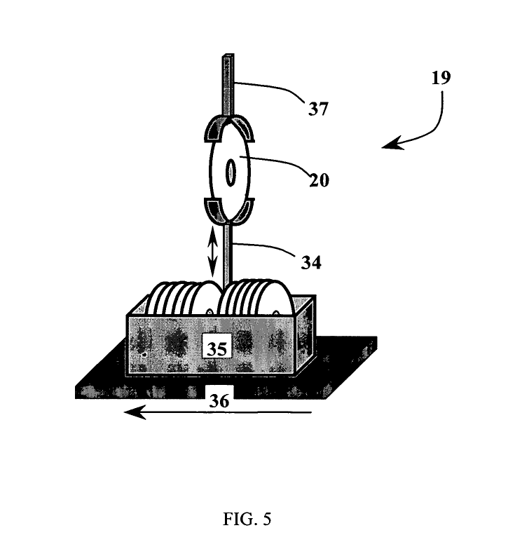

Referring now to FIGS. 1 and 5, the material handling unit 19 comprises a conveyer 36, a lifter 34 and a top guide 37. A detachable cassette 35 as a disk holding and transferring means is also provided for the handling unit 19. The cassette 35 holds one or more disks that are to be marked, and can be transported by the conveyer 36. In a marking process, the conveyer 36 transfers to a preferable position the to-be-marked finished glass disks in the cassette 35. After the cassette 35 reaches the preferable position, the lifter 34 heaves one disk 20 till the disk touches the top guide 37. After the disk 20 is fixed stably by the top guide 37, the PC processor 10 sends a signal 51 to the x-y scanner inside the galvanometer 18 and a signal 38 to the CO₂ laser generator 12 synchronously to mark a desirable pattern such as alphanumerical characters, code and index. When the marking on the disk 20 is finished, the lifter 34 moves the disk 20 down and places the marked disk back inside the cassette 35. This process will be repeated until all the disks in the cassette 35 have been marked. Then, another cassette with unmarked disks will replace the one with marked disks by the conveyer 36. The whole operating process of the handling unit 19 is controlled by the PC processor 10 through by a bi-directional signal 52.

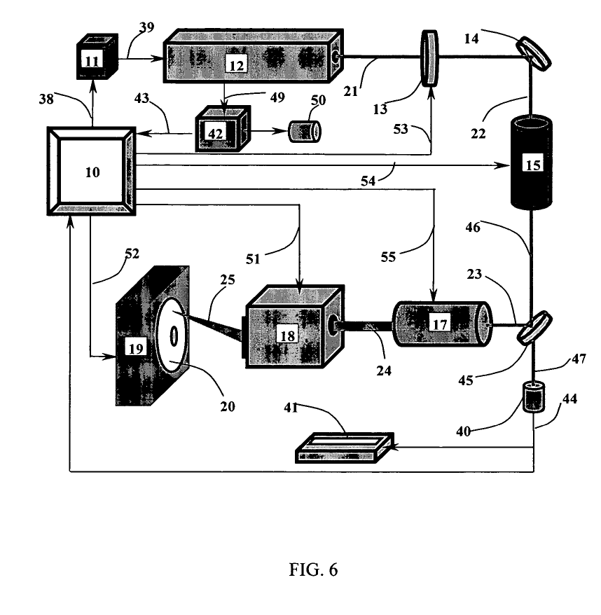

Referring now to FIG. 6, another embodiment of the laser marking apparatus is shown. In this embodiment, the normality of laser pulse energy from laser generator and optical path may be monitored by two monitoring systems. The first monitor system comprises a P polarizing beamsplitter 45, a detector 40 and an energy meter 41. The P polarizing beamsplitter 45 substitutes the beam reflector 16, as discussed above. The P polarizing beamsplitter 45 can be used to split the laser beam from the attenuator 15 into two parts with one going to the beam modifying and energy stabilizing system and the other going to the detector 40. The ratio of these two parts shall be determined based on specific marking processes. For instance, the P-polarizing beamsplitter 41 deflects 98% of the laser beam 46 to the beam modifying and energy stabilizing system 17 and permeates 2% of the laser beam 46 as a beam sample 47 to the detector 40. After receiving the beam sample 47, the detector 40 generates a response signal 44 that is being sent synchronically into the energy meter 41 and the PC processor 10. The energy meter 41 displays the response signal 44 as the value of the laser pulse, and the PC processor 10 compares the response signal 44 with the preset standard value. When the energy of the laser beam satisfies the preset standard value, the difference is about zero. However, the energy of laser beam may vary in certain circumstances including a higher temperature in water coolant, beam mis-alignment caused by some vibration and damage of some optic mirrors in the optical path. Whenever any of such circumstances happens, the response signal 44 sent by the detector 40 may be a strong or weak one. When the PC processor 10 detects a difference between the response signal 44 and the preset standard value, it will interrupt the command pulse 38, send a command instruction 53 to turn off the shutter 13, and stops the marking process. Meanwhile, the energy meter will display the higher or lower value of laser pulse. Therefore, the bad marking quality on the surface of finished glass disks can be substantially minimized during the marking process.

The second monitoring system monitors the normality of the laser generator 12. This monitoring system is a complex detector 42 comprising a temperature sensor, a flow sensor and a water level sensor. All of these sensors receive a signal 49 from the laser generator 12. When the temperature inside the laser head and power supply of the laser generator 12 increases over a preset value, or the flow and water level inside the chiller is lower than the preset value, the complex detector 42 will generate a warn signal 43. The warn signal 43 will be sent into the PC processor 10 which in turn interrupt the command pulse 38 and turn off the shutter 13. An alert system 50 is also optionally provided in this system. Upon receiving the warning signal 43, the PC processor 10 may activate the alert system 50 that may emit alert red light and/or sound. Therefore, one evident benefit of this monitoring system is that it may substantially eliminate damage of the laser head and power supply of the laser generator 12 due to overheat caused by high temperature.

Referring now to FIGS. 1 and 6, the PC processor unit 10 is personal computer installed with all necessary software. The PC processor unit 10 controls the emission of the CO₂ laser 12, the attenuator 15, the shutter 13, the galvanometer 18 and the handling system 19 separately.

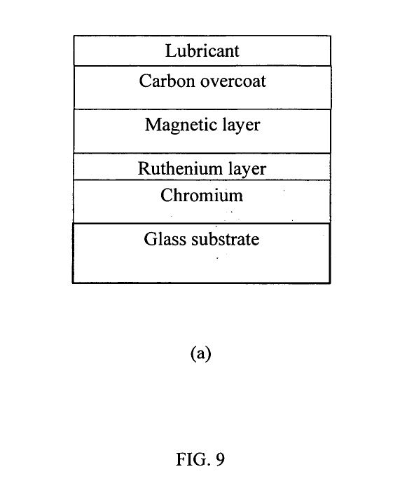

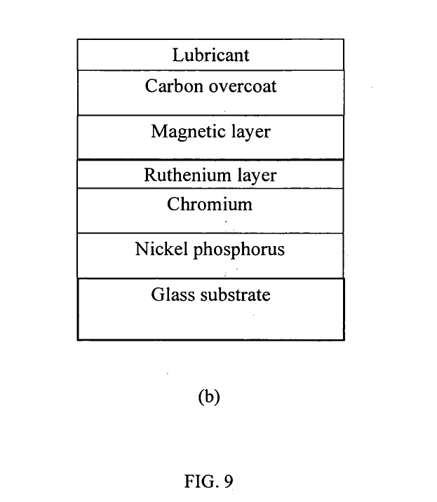

Now a representative process of marking a finished non-metallic disk is described using the laser marking apparatus of the present invention. The finished non-metallic disk is conventionally produced according to standard industry practices. FIG. 9 illustrates two examples of the finished glass disks that can be used for laser marking by the laser marking apparatus of the present invention. Referring to FIGS. 5 and 9, each finished glass disk 20 has a glass substrate, and above the substrate are five or six layers of different materials. For five layers shown in FIG. 9(a), the topmost layer is an organic lubricant. A finished disk without the organic lubricant can also be marked by the present invention. In some embodiments, the organic lubricant layer can be a few nanometers thick. Below the lubricating layer is a carbon layer. In some embodiments, the carbon layer has a thickness of about 50 angstroms. The coal overcoat material comprises a carbon nitrogenated or hydrogenated to produce a protective, diamond-like substance. Beneath the carbon layer is a magnetic layer. In some embodiments, the magnetic layer has a thickness about 200 angstroms. This magnetic layer is mainly made up of cobalt chromium platinum boron (CoPtCrB). The finished disk also contains a chromium underlayer (e.g.,300 angstroms) and a ruthenium layer (e.g., 6 angstroms). For the six layers, there is an additional nickel phosphorus layer (e.g., 300 angstroms) between chromium underlayer and glass substrate, as shown in FIG. 9(b). During the marking process, the finished disks are loaded into the cassette 35 of the material handling unit 19.

When the marking process starts, the power supplies for the PC processor 10 and the CO₂ laser generator 12 are switched on. After the pre-warm up, the PC processor 10 sends the pulse command 38 for the pulse calibration 11. The software of the pulse calibration 11 calibrates the first few pulses from the CO₂ laser generator 12 by the calibration command 39. The calibrating procedure is to check the height of first several bumps by comparing with the height of the stabilized bumps. If their height is lower than that of the stabilized bumps, the width of the command pluses for the first few laser pulses is increased accordingly The calibrating procedure is to check the height of first several bumps compared with the height of later stabilized bumps. If the height of the first several bumps is lower than that of the stabilized bumps, the width of the command pluses for the first few laser pulses is increased accordingly till their heights are as same as that of the stabilized bumps. Then, the parameters of the width of the pulses will be stored in the software. Therefore, the software would automatically apply the same parameters to all the first few pulses whenever the laser generator is switched on.

In its simplest form, after the calibration, the laser beam 21 emerging from the laser head is passed through the shutter 13, the first beam reflector 14, the attenuator 15, the second beam reflector and the beam modifying and energy stabilizing system 17. Then, the laser beam 25 after passing through a galvanometer 18 is positioned and focused onto the surface of the finished glass disk 20 that is manipulated by the material handling unit 19.

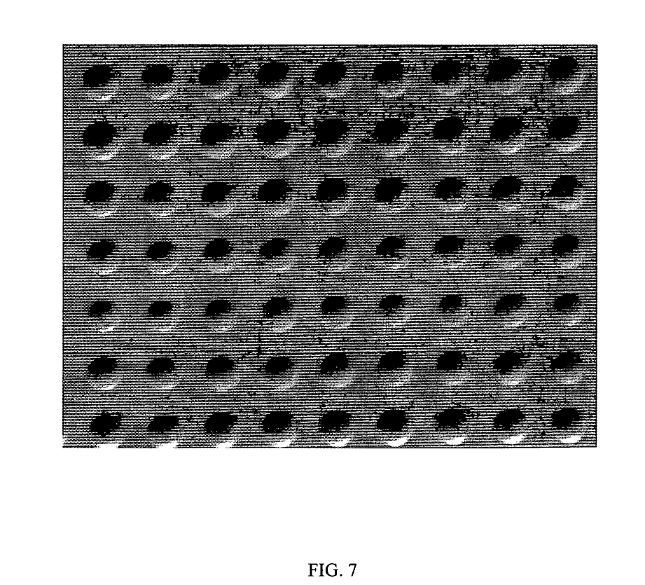

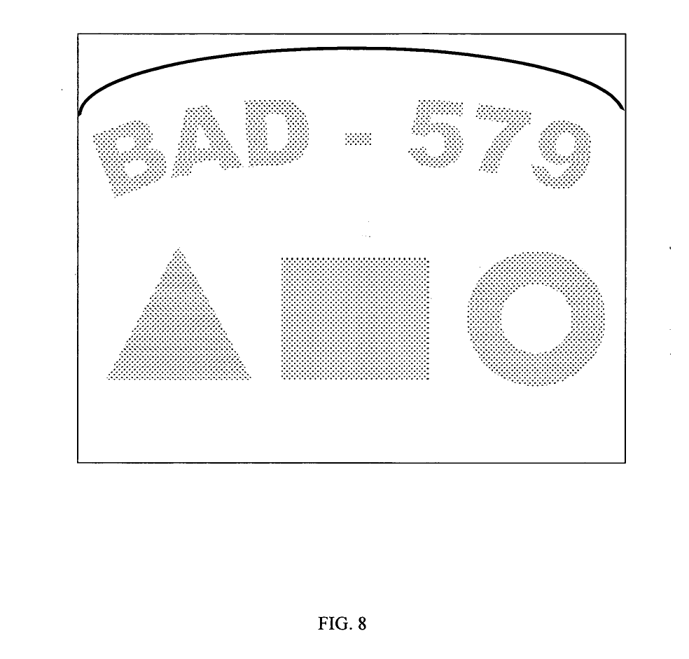

Since a CO₂ laser is operated in PWM mode, the laser beam emerges as pulse formation. The laser-induced dot-like bumps will form along a scan line while the laser beam is steered across the surface of a finished glass disk by the x-y scanner inside the galvanometer 18, as shown in FIG. 7. These visible bumps can be used to produce patterns of alphanumeric characters, codes and indexes for labelling purposes, as shown in FIG. 8. The height of the bumps is dependent on the laser power and/or the energy of laser pulse. Software files can be used to determine the spacing between two adjacent bumps.

The laser marking apparatus has been optimised to induce marks on the surfaces of the multi-layered finished glass disks without undesirable effects. Process analyses indicated that, with a suitable laser power and beam size, the different layers of the disks still remain intact after the marking process. The surface protruding structures induced on the top surface brings about the visible contrast ideal for the marking process.

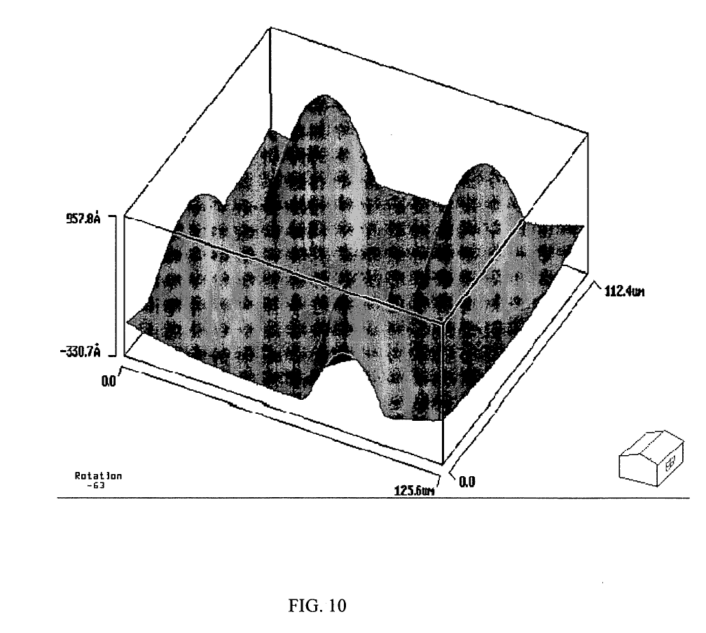

The laser marking process induces a variety of shapes of the bumps formed on a finished disk. FIG. 10 shows on a finished glass disk with nickel phosphor layer a protruding structure bearing the dome-shape. The height of the protrusion can reach 120 nanometer with a range of between 20 and 120 nanometer, depending on the intensity of the laser power and/or laser pulse energy. The diameter of the bumps is between 10 and 45 micrometer, determined by both beam diameter on double F-Theta lens and the intensity of the laser power. Preferably, such a structure is linked to the axial-symmetrical Gaussian-shaped intensity distribution of the laser beam. No micro-cracks or burnt outs were seen in the top tip of the protruding structure. Without intention to be bound by any theories or explanation, the bump formation mechanism is believed that the energy of the laser pulse is absorbed by not only the sputtered film layers but also the glass substrate to quickly generate a heat in the laser hitting area. This heat will cause an upward thermal expansion in the heated area due to the poor heat conductivity of glass material so that the layers cover on glass substrate protrudes to form a visible bump with dome shape. An adequate energy of a laser pulse can produce enough protrusion of the laser-induced area but not cause a cracking and burning. In this way, the visible bumps without being cracked and burnt out can be achieved on the surface of a finished glass disk with and without nickel phosphorus layer or other layer in the present invention.

The contrast marking effect on the surface of a finished glass disk is dependent on the following factors: (1) The number of laser bumps; (2) The height of protrusions; (3) The diameter of bumps. The increase of the laser bumping number enhances the marking contrast. However, increased laser bumps will cause the marking speed reduced. The number of laser bumps is limited by the precision of the scanner. With respect to the height of the protrusion, the higher the protruding structure is, the better the marking contrast will be. In order to achieve the highest protrusion of all laser bumps without being cracked or burnt out, the fluctuation of the laser power should be as minimized as possible. Otherwise, a high fluctuation of laser power will cause a contamination due to some laser bumps being cracked and burnt out, or low marking contrast due to some laser bumps being reduced in height. In the present invention, the pulse calibration 11 and the beam modifying and energy stabilizing system 17 are used to minimize the fluctuation of the laser power and laser pulse so that a uniform distribution of the highest protrusions can be achieved. When the laser bumping number and height of the protrusion are fixed, the increase of the bumping diameter will increase the marking contrast, which is achieved by adjusting raw beam diameter in the beam modifying and energy stabilizing system 17.

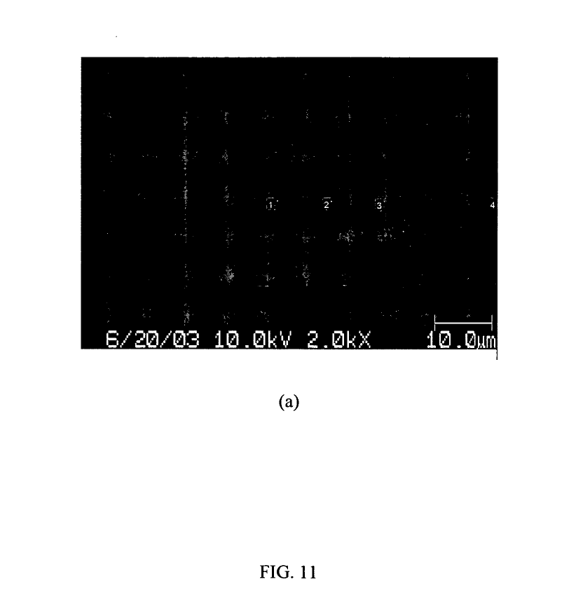

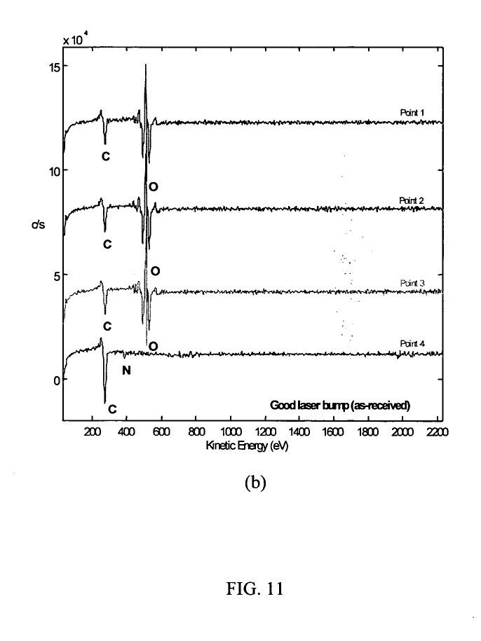

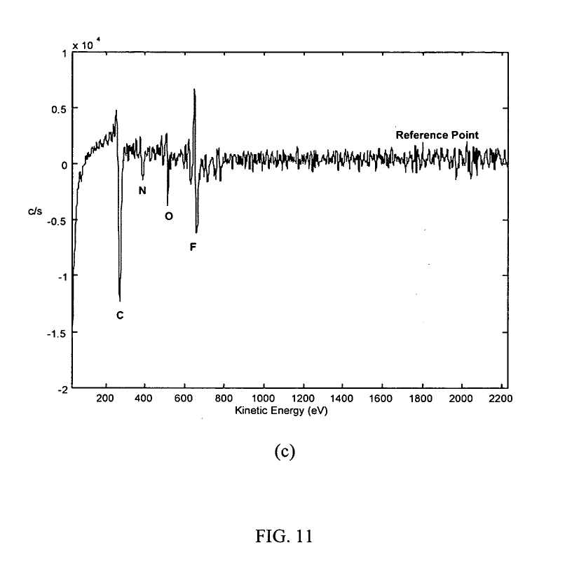

The surface morphologies of finished glass disks after laser irradiation were investigated using an atomic force microscope (AFM). As discussed above, FIG. 10 shows a representative of the AFM image of the CO₂ laser-induced protruding structures without cracked and burnt out during laser marking on a finished glass disk with nickel phosphorus. In addition the Auger electron spectroscopy (AES) was also used to study. As shown, FIG. 11 is a representative of an AES radial position analysis; (a) a showing of the AES radial position performed on the structure as shown in FIG. 10; (b) the AES radial results of the irradiated region; (c) the AES radial results of a non-irradiated region on the same disk specimen. Comparison of the irradiated regions of FIG. 11(b) with non-irradiated regions of FIG. 11(c) on the same disk specimen reveals that the carbon layer of the irradiated regions remained very intact and only the lubricant layer with fluorine and nitrogen elements was evaporated off. Furthermore, the carbon, magnetic, chromium and nickel phosphorus interfaces were still preserved. This demonstrates that the laser-induced deformation of this type can be used to induce the formation of the surface protruding structures ideal for a marking process.

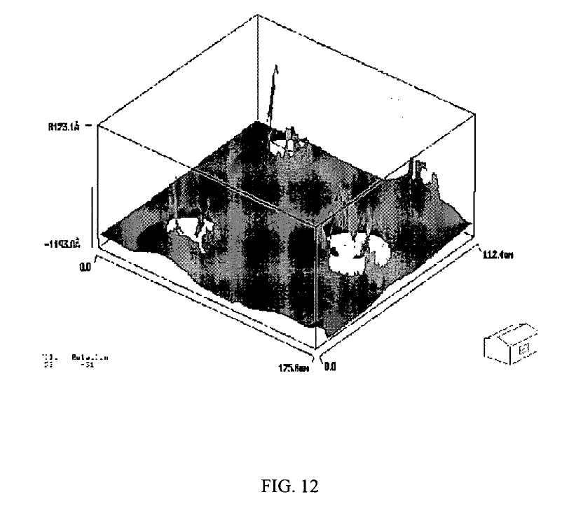

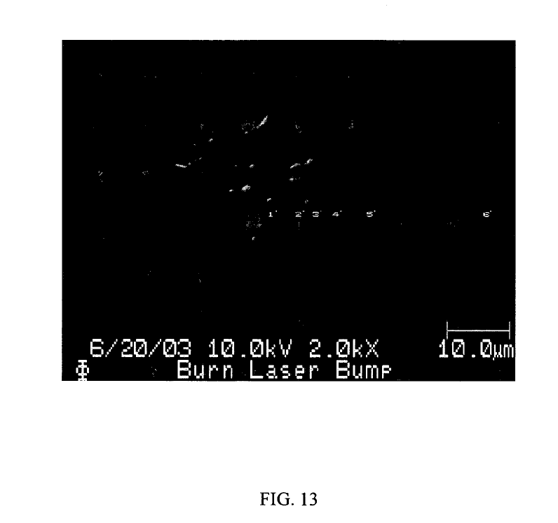

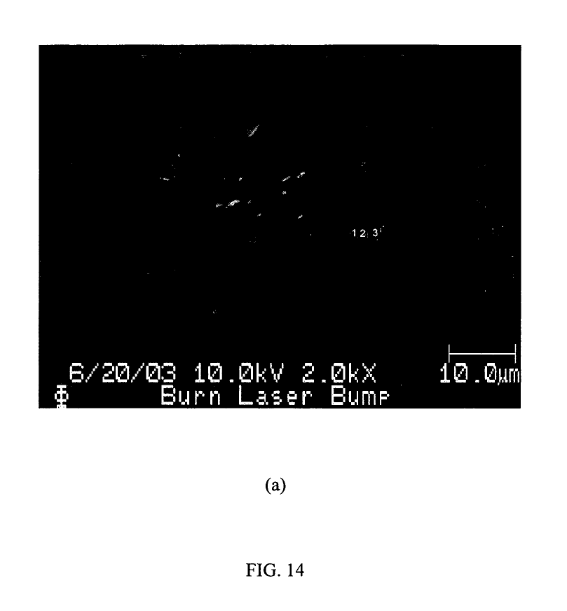

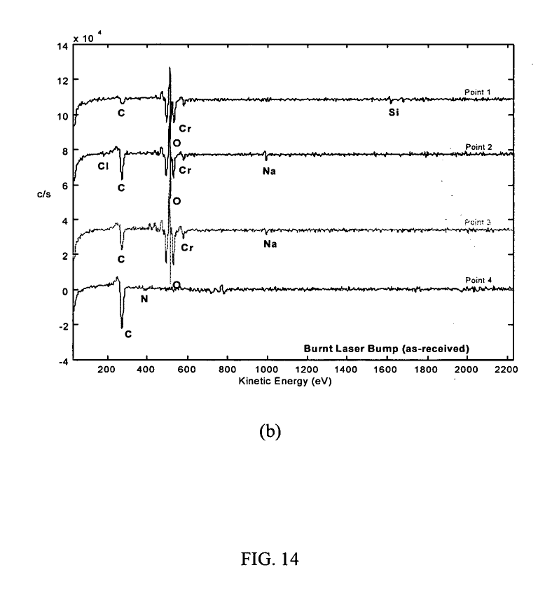

Using higher energy of laser pulse, the laser-induced structure with a cracked and burnt through morphology is shown in FIG. 12. The higher protrusion created by excessive heat leads to a cracking or breakage on the top of the dome bumps because the sputtered layers of a finished disk are too thin. In addition, the temperature of the sputtered film layers will also rise into the burning point due to the increase of the absorbed heat, which results in the sputtered film layers burnt out and glass substrate melt in the center of the bump, as shown in FIG. 13. This is why there is no spectra were collected on points 1 to 4 due to only insulated glass existed. Only on the fringe of a dome shaped protrusion, a mixture of carbon, chromium, sodium, silicon and chlorine was found, as shown in FIG. 14. As the carbon overcoat layer, serving as a protective layer for the disk, has already been destroyed, such a laser-induced deformation can lead to severe damage and contamination on the surface of the finished glass disk.

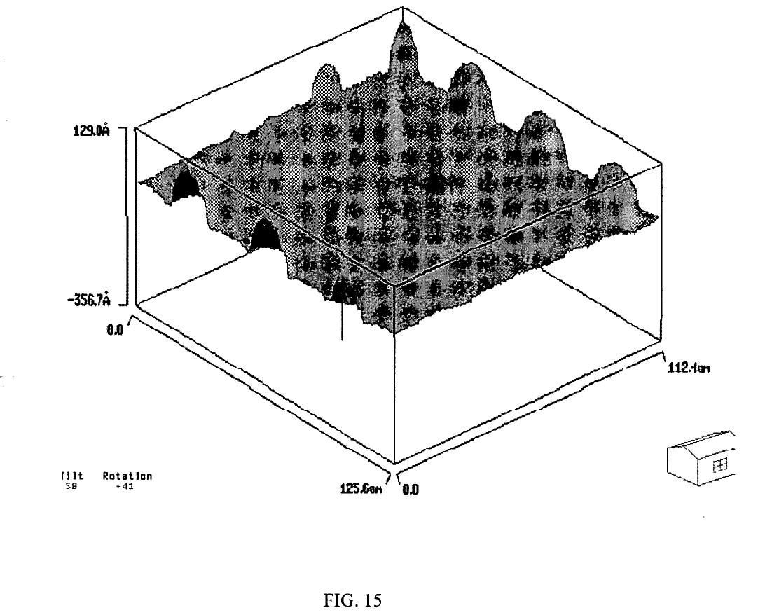

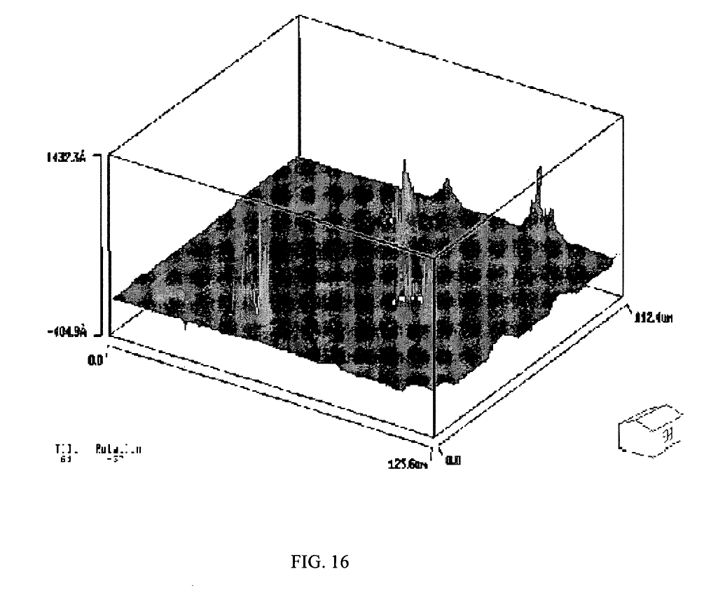

FIG. 15 shows the bumps on the surface of a finished glass disk with nickel phosphor layer that was marked by using a near IR wavelength (1064 nanometer) laser, i.e. Nd. YAG laser, where the YAG laser-induced bumps were not cracked or burnt out. However, the results indicated that the maximum height of protruding structure on the surface of finished glass disk was less than 13 nanometer, far lower than that achieved by CO₂ laser with wavelength 10.6 micrometer. This height of bumps is too low to be visible for a naked eye. Moreover, the height of bumps could not be increased by simply increasing the energy of the laser beams used for the laser marking process, because further increase of the laser power resulted in some bumps broken and burnt out, as shown in FIG. 16. The reason may be that the laser beam penetrates the glass substrate due to its optically transparent for near IR wavelength laser. The heat accumulated on between multi-players and glass substrate is so little that the upward thermal expansion is hardly formed. Therefore, a higher bump cannot be achieved. Increase of the laser power will only cause the surface temperature being raised into a burning point of sputter film layers. As a result, the bumps are cracked and burnt out.

While the foregoing has presented descriptions of certain preferred embodiments of the present invention, it is to be understood that these descriptions are presented by way of example only and are not intended to limit the scope of the present invention. It is expected that others skilled in the art will perceive variations which, while differing from the foregoing, do not depart from the spirit and scope of the invention as herein described and claimed.

1. A laser marking apparatus for producing a visible protruding structure on the surface of a finished non-metallic substrate disk magnetic storage media, comprising:
a CO₂ laser generator for generating an output laser beam, wherein the output laser beam is calibrated by calibrating the first few command pulses of the output laser beam by applying a pulse-width compensation;
an attenuator disposed in the optical path of the laser beam from said first reflector for adjusting the beam intensity;
a beam modifying and energy stabilizing system disposed in the optical path of the laser beam from said second reflector, minimizing the fluctuation of the pulse energy, improving the quality of the laser beam from said second reflector and producing a desired beam spot size of the laser beam after being focused onto the disk surface;
a galvanometer disposed in the optical path of the laser beam from said modifying and stabilizing system for scanning and marking the disk; and
a handling system disposed in the optical path of the laser beam from said galvanometer for holding and transferring the disk during a marking process.

2. The laser marking apparatus of claim 1, further comprising a shutter disposed in the optical path of the output laser beam for blocking off the laser beam.

3. The laser marking apparatus of claim 1, further comprising a first reflector disposed in the optical path of the output laser beam for changing the delivering direction of the output laser beam.

4. The laser marking apparatus of claim 1, further comprising a second reflector disposed in the optical path of the laser beam from said attenuator for changing the delivering direction of the laser beam from said attenuator.

5. The laser marking apparatus of claim 1, wherein said attenuator comprises two Brewster windows.

6. The laser marking apparatus of claim 1, wherein said beam modifying and energy stabilizing system comprises a first adjustable aperture and a second adjustable aperture for minimizing the fluctuation of the pulse energy of the laser beam, and a beam collimator/expander for amplifying and collimating the laser beam.

7. The laser marking apparatus of claim 1, wherein said galvanometer comprises a x-y scanner for scanning the surface of the disk and a double F-Theta lens for focusing the laser beam from said beam modifying and energy stabilizing system.

8. The laser marking apparatus of claim 1, wherein the handling unit comprises a conveyer for transporting disks, a lifter for moving the disks up and down, and a top guide for designating the extent to which the disks can be moved up by the lifter.

9. The laser marking apparatus of claim 1, wherein the protruding structures are dome shaped bumps.

10. The laser marking apparatus of claim 9, wherein the dome shaped bumps have heights with a range of between 20 and 120 nanometers.

11. The laser marking apparatus of claim 1, wherein the finished non-metallic substrate disk has a glass substrate.

12. The laser marking apparatus of claim 1, further comprising a processor, wherein the processor functions for calibrating the output laser beam, and receiving signals from , processing, and sending signals to one or more parts of said laser marking apparatus including the material handling unit, the pulse calibration, the shutter, the attenuator, the beam modifying and energy stabilizing system, the galvanometer and the material handling unit.

13. The laser marking apparatus of claim 12, wherein the processor is a personal computer.

14. The laser marking apparatus of claim 1, wherein the CO₂ laser generator has a pulse width modulation (PWM mode) with M²<1.2, unitary frequency and a wavelength of 10.6 μm.

15. The laser marking apparatus of claim 1, further comprises a first monitor system having a P polarizing beamsplitter for splitting the laser beam from said attenuator, a detector for detecting one part of the split laser beam, and an energy meter for displaying a response signal from the detector.

16. The laser marking apparatus of claim 1, further comprises a second monitor system having a temperature sensor, a flow sensor and a water level sensor, whereby the sensors receive a signal from said laser generator.

17. The laser marking apparatus of claim 1, wherein the finished non-metallic substrate disk has five layers including a carbon overcoat layer, a magnetic layer, a ruthenium layer, a chromium layer, and a glass substrate.

18. The laser marking apparatus of claim 1, wherein the finished non-metallic substrate disk has six layers including a carbon overcoat layer, a magnetic layer, a ruthenium layer, a chromium layer, a nickel phosphorus layer and a glass substrate.

19. A method for producing a visible protruding structure on the surface of a finished non-metallic substrate disk magnetic storage media by using the laser marking apparatus of claim 1, comprising steps of:
calibrating the laser beam generated by the laser generator by pulse calibration;
passing the calibrated laser beam from the laser generator through the attenuator and the beam modifying and energy stabilizing system, wherein the laser power can be selected, the laser mode can be improved, and the fluctuation of laser power from laser generator and optic path can be minimized; and
directing the modified laser beam into the galvanometer, wherein the modified laser beam is directed by an x-y scanner and focused by F-Theta lens to the surface of a workpiece held by the materials handling unit.

20. A finished non-metallic substrate disk manufactured by claim 15, wherein said finished non-metallic substrate disk has dome shaped bumps.

21. The finished non-metallic substrate disk of claim 20, wherein said finished non-metallic substrate disk has a glass substrate.
